(19) United States
(12) Patent Application Publication
(10) Pub. No.: US 2025/0091027 A9
(43) Pub. Date: Mar. 20, 2025

(54) MULTILAYER REACTOR WITH MULTIPLE STRUCTURAL LAYERS

(71) Applicants: Karlsruher Institut für Technologie, Karlsruhe (DE); INERATEC GmbH, Karlsruhe (DE)

(72) Inventors: Peter Pfeifer, Linkenheim-Hochstetten (DE); Sebastian Schmidt, Heidelberg (DE)

(21) Appl. No.: 18/543,905

(22) Filed: Dec. 18, 2023

Related U.S. Application Data
(63) Continuation of application No. PCT/EP22/64420, filed on May 27, 2022.

(30) Foreign Application Priority Data
Jun. 18, 2021 (DE) 102021115881.8

(51) Int. Cl. B01J 19/00; B01J 19/24

(52) U.S. Cl. CPC B01J 19/0053; B01J 19/0093; B01J 19/2425; B01J 19/248; B01J 2208/00548; B01J 2219/2456

(57) ABSTRACT

The present invention relates to a reactor having a multilayer structure, wherein the different layers are structured in a particular manner, in preferred embodiments comprising square openings to enable an improved heat transport during catalytic reactions. Furthermore, the present invention relates to multi-reactor structures, methods for providing the reactors and multi-reactor structures, as well as uses and applications.

All documents cited in the present application are incorporated by reference in their entirety into the present disclosure.

The present invention relates to a reactor having a multilayer structure, wherein the different layers are structured in a particular manner to enable an improved heat transfer during catalytic reactions. Furthermore, the present invention relates to multi-reactor structures, methods for providing the reactors and multi-reactor structures, as well as uses and applications.

### PRIOR ART:

In (micro)structured reactors, solid catalysts can be introduced as layers or as fillings of particles. Such reactors are usually used for fast and high-energy reactions in order to ensure an efficient heat inflow or outflow by means of a layered structure, i.e. by alternating planes with a through-flow of reaction medium and heat transfer medium, and thus to conduct the reaction as close as possible to the temperature nominal value. When filling such a reactor with particles, the small dimensions of the structures in a plane result in a structure to particle size ratio of less than 10 in order to on the one hand minimise the pressure loss when the reaction medium flows through and on the other hand to prevent the adhesive forces between individual particles from becoming greater than the weight of the individual particles, thereby avoiding agglomeration. Agglomeration is unfavourable and hinders the filling of the structures with catalyst. As due to the flat wall surface and the particle contacts a higher bed porosity near the wall is given, a small structure to particle size ratio results in a considerable influence of the reduced porosity near the wall and thus an uneven velocity of the reactants. Milled or etched structures with staggered columns, as in WO 2017/013003, are one approach to improving the uniform flow. The cost-intensive production of structures and the fact that the mixing at the columns is only a two-dimensional approach mean limitations.

Reactors described in the prior art usually have one or more catalyst(s) for carrying out at least one exothermic reaction. As the catalytic activity decreases, this catalyst must be renewed at regular intervals known to the skilled person by removing it from the reactor and refilling it. For this purpose, the reactor must allow the catalyst to be loaded and removed evenly. To dissipate the exothermic energy by means of heat conduction, a material connection to the cooling passage is also required. These connections must not exceed a maximum distance. This results in various challenges. For example, due to their design, the individual layers are essentially only suitable for use in diffusion-welded microstructure reactors. There must be as many continuous superimposed connections as possible perpendicular to the direction of flow so that the heat transfer is maximised through several planes of plates to the next cooling plane.

In state-of-the-art reactors, it is often a problem that the flow cannot distribute sufficiently evenly in the cavities in the reactor and uneven porosities of the bed and the porosity differences near the walls are not sufficiently equalised so that the residence time of the reactants is the same in all catalyst zones.

Also, the catalyst should be fillable evenly into the reactor chamber and removable again; in some prior art designs, this is not or only marginally achieved.

Furthermore, on the one hand as much catalyst volume as possible should be introducible into the reactor, but the heat exchange and heat transport should be as high as possible so that the conditions in the reactor are as isothermal as possible. This problem is also often not adequately addressed in reactors according to the prior art.

From WO 90/13784 A1, for example, various heat exchanger structures are known, but no reactors and no hints to the much more difficult flow conditions and resulting challenges which are caused by a catalyst bed.

From EP 1 995 545 A2, for example, a design comprising rectangular channels is known, the use of which, however, can lead to preferential flows forming within the catalyst bed, caused by uneven pressure losses across the flow cross-section in the main flow direction, so that uneven pressure and thus flow conditions form and this can lead to an uneven temperature distribution in the reactor and ultimately to lower selectivity.

From WO 2006/102675 A1 structures are described with a main channel in which different layers are superimposed by at least 50%. The structures require Reynolds numbers greater than 100 and the structures should be coated with a catalyst.

EP 2 543 434 A1, US 6,968,892 B1 and DE 10 2011 079 634 A1 could also be mentioned as further prior art.

In this respect, based on the known prior art, there is still a considerable need to improve the previous prior art.

### Object:

Accordingly, the object of the present invention was to overcome the disadvantages of the prior art described above and to provide reactors which no longer exhibit these problems, or at least only to a considerably lesser extent.

A reactor design was to be found that allows more flexibility in production and is not limited to diffusion welding, but also allows other types of production.

A design should further be found in which the flow can be distributed evenly in the cavities in the reactor to an improved extent compared to the prior art and in which uneven porosities of the filling as well as the porosity differences near the walls can be equalised.

The reactors should also be easy to fill with catalyst and the catalyst should then be easy to replace.

In addition, reactors should be found in which, on the one hand, an as high as possible portion of catalyst volume can be introduced, but on the other hand, the heat exchange and heat transport is as high as possible, so that the conditions in the reactor are as isothermal as possible.

Furthermore, reactor structures coated with catalyst or catalytically active material are to be dispensed with in order, on the one hand, to enable simpler production and, on the other hand, to enable filling and refilling, possibly also with other catalysts.

Further objects arise for the skilled person when considering the claims and from the following description.

### Solution:

These and further objects, which arise for the skilled person from the present description, are solved by the subject matter outlined in the claims, the dependent claims representing preferred and particularly advantageous embodiments.

In the context of the present invention, all indications of quantity are to be understood as indications by weight, unless otherwise stated.

In the context of the present invention, the term “ambient temperature” means a temperature of 20° C. Unless otherwise stated, temperature specifications are in degrees Celsius (° C.).

Unless otherwise stated, the reactions or process steps mentioned are carried out at ambient pressure (=normal pressure/atmospheric pressure), i.e. at 1013 mbar.

Unless otherwise stated, pressure data in the context of the present invention mean absolute pressure data, i.e. x bar means x bar absolute (barₐ) and not x bar gauge.

In the context of the present invention, the reactor front side is understood to be the side from which the reaction medium/fluid flows into the reactor.

In the context of the present invention, the term “side wall” in connection with diffusion-welded multilayer reactors is understood to mean the region on the left and right sides of the multilayer reactor (in contrast to the reactor front side and the rear side opposite it), which connects the top side and the bottom side to each other and seals them off from the outside.

In the context of the present invention, the “points” at which the various (structural) layers are connected to one another are to be understood as real points (i.e. small areas) and not mathematical points, i.e. in this respect what is usually understood by connection points in mechanics or in mechanical devices.

In the context of the present invention, the term “temperature lift” is understood to mean the maximum temperature difference compared to the actually desired reaction temperature (in particular in the sense of an excess temperature that arises compared to the target temperature).

Subject matter of the present invention is in particular a reactor with a, preferably welded, multilayer structure which has an upper fluid-tight cover layer, a lower fluid-tight cover layer, fluid-tight side walls and, located therebetween, at least one reaction space which is defined by several superimposed structural layers parallel to the cover layers.

The individual structural layers each have a structure of parallelograms arranged periodically in several rows, in each case edge-to-edge, wherein the parallelograms are preferably rectangles, particularly preferably rhombi, in particular squares, and wherein the areas of the parallelograms are designed as openings and the edges are designed as webs.

Each of the structural layers is offset by a factor of 0.5+0.2 and 0.5+0.2 in the x and y directions relative to the layer above or below it, preferably ±0.1 in each case, in particular preferably ±0.05 in each case; wherein the largest edge length of the rhombi is standardised as 1 and therefore specifies the x direction, the y direction is orthogonal to this in the plane of the structural layer.

The side edges of the parallelogram structures in the structure layers are arranged rotated by 30 to 60° , preferably 45 to 55° , particularly preferably 40 to 50° , especially 45° , in relation to the front and rear sides of the reactor, whereby incomplete parallelogram structures with openings not completely surrounded by webs at the front and rear of the reactor result.

At the side edges of the reactor, the parallelograms which are not complete due to the geometry can either be partially open openings or closed openings (this is also illustrated, for example, by FIGS. 1 to 4).

In the reactor of the present invention, the reaction space is laminary flowed against from the front of the reactor, with the fluid flowing against flows into the openings that are not completely surrounded by webs.

The cover and structural layers consist of material with good thermal conductivity, preferably material with a thermal conductivity of 10 to 400 W/(mK). Preferably, the material is a weldable material, particularly preferably selected from the group consisting of nickel-based alloy(s), aluminium (thermal conductivity of about 300 W/(mK)), aluminium alloy(s), copper (thermal conductivity of about 400 W/(mK)), stainless steel, high-temperature alloys such as in particular 1.4876 or 2.6433 or mixtures thereof, in particular stainless steel. In a variant of the present invention, materials are selected which have a thermal conductivity of 12 to 25 W/(mK).

The contact points and areas of the webs of the superimposed structural layers are fully connected to each other, in particular welded. These connections are fluid-tight.

Catalyst bed can be arranged in the openings between the webs of the structural layers; in preferred variants, catalyst bed is arranged in the openings between the webs of the structural layers. The catalyst bed can be immobilised or retained in various ways, for example by retention devices or by bonding.

The coverage of the openings of one layer by the webs of the layer above is 30-60%, preferably 30 to 55%.

In preferred embodiments of the present invention, the reactor has specific dimensions.

In these embodiments, the structural layers each have a thickness of 0.3 mm to 2 mm, preferably 0.5 mm to 1 mm, the webs have a width of 0.5 mm to 4 mm, preferably 1 mm to 3 mm, and the largest side length of the openings is between 2 mm and 20 mm, preferably between 4 mm and 12 mm.

The cover layers have thicknesses in the same range as the structural layers, i.e. from 0.3 mm to 2 mm, preferably 0.5 mm to 1 mm; however, however, the thicknesses used in each case are independent of those of the structural layers. In some embodiments, the cover and structural layers are manufactured from the same raw material (e.g. sheet metal or metal foil) and then have the same thickness. In other embodiments, the thicknesses of the cover layers are selected differently from those of the structural layers depending on the desired heat dissipation, or also for additional mechanical stabilisation (then thicker than the structural layers).

It is also important that the openings are wider than the web width by at least a factor of 2, preferably at least a factor of 3. Below a factor of 2, the space through which a catalyst bed can be filled and the reaction medium can flow gradually becomes too small; with a factor of 1, i.e. when the webs are as wide as the openings, there is no space at all to flow through. On the other hand, the factor should not become too large so that sufficient heat dissipation of the reaction heat via the webs is still possible. In specific embodiments, this upper limit of the factor is at a maximum of 6, preferably at a maximum of 5. In particular, the factor is between 3 and 6.

In the case of a rhombus or a square as a special case of a parallelogram, the largest edge length is naturally equal to the other edge length.

With this, as well as all other dimensional data for the present invention, it is understood by the skilled person that production-related tolerances are included; as the skilled person is aware, these may differ depending on the production technique (for example, a punching process generally has different tolerances than a laser cutting process, a process for additive manufacturing or a water jet process).

In some embodiments of the present invention, these structural dimensions may differ for successive layers. In this case, however, it is essential that sufficient space remains for filling or flow, as described analogously in the previous paragraph. However, for production-related reasons and in order to achieve results that are as uniform as possible, structural layers are generally stacked on top of each other, which have the same structural dimensions.

In further preferred embodiments of the present invention, the reactor has a ratio of web width to longest side length of the openings of between 0.15 and 0.55, preferably between 0.25 and 0.45, averaged for all structural layers or, preferably, always the same for each individual structural layer. If the ratio is too small, the limit for a technically reasonable weldability of the layers is not reached. If the ratio is too high, on the other hand, the sensible limit for catalyst bed is exceeded. This is because if there is too much catalyst in relation, the heat removal via the webs of the individual structural layers may no longer be possible to a sufficient extent.

However, it is be heeded in this context that the lower limit may be shifted for additive manufacturing processes, i.e. 3D printing in particular. Nevertheless, the above-mentioned limits are also preferred in this case.

In further preferred embodiments of the present invention, the reactor has an empty volume portion of 45 vol. % to 75 vol. %, preferably 50 vol. % to 70 vol. %, particularly preferably 60 vol. % to 70 vol. %. Although the reactor of the present invention is not limited to operation with a filling of catalyst bed, it is particularly well suited and primarily designed for such operation. The reactor has proven to be particularly suitable in these mentioned fields.

In this respect, the empty volume for operation is filled with a filling of fine catalyst particles, which are preferably spherical. This is therefore a particularly preferred embodiment of the present invention.

In this context, it should be noted that the aspect of utilising the cavity for filling with catalyst is an essential feature of the present invention. It is important in this context to be able to integrate a certain amount of catalyst per volume and at the same time to be able to dissipate the heat efficiently.

In further preferred embodiments of the present invention, an opening dimension of 6 mm and a web width of 1.5 mm are formed for square openings. This results in an empty volume portion of 64%. It is particularly advantageous to maintain certain limits on the web widths so that the ratio between the heat released and the heat dissipation capacity of the structure does not change drastically. The reactor according to the invention can be used, for example, for methanol synthesis, FT synthesis or methanisation, i.e. reactions which, under intensified microstructuring conditions, can have a volumetric energy release of at least 3 kW/L (minimum 2 kW/L) in the reaction volume. This energy must therefore be dissipated via the webs and the junctions. This is possible with the preferred web dimensions according to the invention. The energy released on the total volume (i.e. the volume occupied including the webs) should preferably be greater than 1 kW/L for a high degree of process intensification, which is why an empty space portion of at least 50% is preferred in some embodiments. An empty space portion of greater than 70% is also not advisable, as heat dissipation via the junctions (contact points) is then not guaranteed.

The size of the individual reactors can be varied within wide limits. Preferred embodiments of the present invention comprise reactor sizes with lengths (flow direction) between 5 cm and 200 cm, preferably between 20 cm and 50 cm. With lengths above this, the flowability of the particle bed within the reactor decreases more and more and finally reaches impracticable values. In preferred embodiments, the width of the reactors according to the invention is between 5 cm and 150 cm, preferably between 30 cm and 80 cm. The height of the reactors according to the invention results from an addition of the thicknesses of the structural layers and the cover layers, as well as any intermediate layers present, and is between 3 mm and 2 cm in preferred embodiments. For example, embodiments can have heights of 5.2 mm or 5.4 mm or 8.4 mm or 9.8 mm.

The dimensions used in practice also depend on the cooling requirements and any heat exchanger elements used (and their effectiveness).

In some preferred embodiments of the present invention, a retention device for the catalyst particles, preferably net-like components or fine-pored metal or ceramic components, in particular fine-meshed wire nets, can be arranged at the front and reactor rear side to safely retain the catalyst particles. It is essential for the catalyst retention device used in each case that it is made of a material that is not catalytically effective for the chemical reaction taking place in the reactor and is inert to the reactants and products. The mesh size or pore size of the catalyst retention device is determined by the size of the catalyst particles used and is selected so that these are retained and do not clog the meshes or pores. Such retention devices are known to the skilled person in principle.

In further preferred embodiments of the present invention, 2 to 10 structural layers, and in particular for a maximum temperature lift of 15K, preferably a maximum of 5K, between 2 and 7, preferably between 3 and 6, structural layers are arranged between the cover layers in the reactor. As a result, particularly good performance profiles can be achieved with regard to heat (removal) transport.

It should be noted that the reactors of the present invention do not comprise rectangular channels and/or a main channel. The structures of the present invention do not allow such channel structures. Moreover, these are geometries that cause poorer results.

In further preferred embodiments of the present invention, the webs and/or walls are not coated with catalyst.

The front and rear sides of the reactor are configured for the inflow and outflow of reaction medium, respectively.

In further preferred embodiments of the present invention, the structural layers on the front and rear sides of the reactor additionally have one or more edges with incorporated channels for distributing the reaction medium during inflow and outflow.

It is equally possible, and preferred in other embodiments of the present invention, that the structural layers at the front and rear sides of the reactor do not have such edges.

Irrespective of this, it is advantageous and thus preferred in embodiments of the present invention if suitable distribution nozzles or distribution spaces for the reaction medium are arranged on the front and rear sides of the reactor, so that a uniform supply or discharge of reaction medium into/from the reactor is ensured. These are well known to the skilled person.

In particular embodiments of the present invention, the outer cover layers of the reactors according to the invention can have ribs on their outer sides, which then protrude into the surrounding medium as a cooler structure.

The essential feature of the present invention that the coverage of the openings of one layer by the ribs of the layer above is 30-60%, preferably 30 to 55%, naturally relates only to the structural layers.

In further preferred embodiments of the present invention, the webs are widened at the points at which they are in contact with those of the underlying or overlying structural layers. Circular widenings are preferred (due to symmetry). Preferably, one widening is arranged in the centre of each web, especially if the offset of the layers is 0.5 in the x and y directions, as defined above. The widening results at most in a doubling, preferably a 40 to 60%, in particular 50%, widening of the web width. However, it is also possible to provide more than one widening per web and also to deviate from the central positioning; in the case of several widenings, it is preferable to arrange them evenly distributed over the respective bar.

However, it is important not to allow the widenings to become too large so that catalyst bed and sufficient fluid flow are ensured.

In further preferred embodiments of the present invention, the reactor according to the present invention is produced by additive manufacturing processes, in particular 3D printing, or by superimposing and then welding the individual layers. In the case of welding of the layers, it is preferred that this is done by means of laser welding, electron beam welding or diffusion welding. In some embodiments, diffusion welding is particularly preferred because then several layers, including the cover layers, can simply be welded together in a single step stacked on the other.

In further preferred embodiments of the present invention, the reactor according to the invention comprises, in addition to the cover layers and the structural layers, intermediate layers which are arranged between structural layers, with the proviso that at least two structural layers are arranged on each side of an intermediate layer before a further intermediate layer or a cover layer is arranged.

These intermediate layers are preferably unstructured layers which - apart from the arrangement within the reactor layer structure - correspond to the cover layers.

In principle, these embodiments can be understood as a direct arrangement of several reactors according to the invention one above the other, with the respective neighbouring reactors sharing a cover layer. This can sometimes be advantageous from a manufacturing point of view, but requires that the resulting arrangement cannot be flexibly taken apart, as is the case with embodiments according to the invention in which several complete reactors according to the invention are arranged one above the other, which do not share any cover layers.

The usable dimensions of the intermediate layers, in particular their thicknesses, correspond to the dimensions of the cover layers, but are selected independently of one another. This means that the length and width must be adapted to the corresponding dimensions of the structural and cover layers of the reactor, but the thickness may differ from the thicknesses of the structural layers or those of the cover layers.

It is also possible that the intermediate layers are structured, whereby their structure differs from that of the structural layers. However, this is less preferred according to the invention and in particular is not realised.

Examples of specific embodiments relating to multiple reactor arrangements according to the invention have the following sequences of the different components on top of each other:
DPD;
DPPD;
DPPPD;
DPPPPD;
DPZPD;
DPZPZPD;
DPZPZPZPD;
DPZPZPZPZPD
DPZPZPZPZPZPD.

Therein means D=cover layer, Z=intermediate layer and P=a pair of structural layers.

Of course, the intermediate layers do not have to be symmetrically surrounded by structural layers (this is simply easier to manufacture in some cases), but can also be distributed asymmetrically, as e.g.:
DPZPPD;
DPPZPPPD;
DPPZPZPPPD:

These reactors are merely exemplary and the present invention is by no means limited to these; many more layers can be arranged on top of each other according to the invention.

The reactors according to the invention can easily be arranged to form multiple reactor arrangements by arranging them on top of and/or next to each other, optionally but preferably with heat exchanger elements arranged in between in each case.

Another subject matter of the present invention is a multiple reactor arrangement comprising several reactors according to the present invention. Here, a plurality of reactors according to the invention are stacked, with heat exchanger elements arranged between each of the individual reactors.

These heat exchanger elements can assume various designs, depending on the reaction carried out in the reactors and the amount of heat to be dissipated or the amount of cold to be supplied.

In this respect, it is also possible that the heat exchanger elements essentially only form a space or that the surrounding space functions as heat exchanger element and the heat exchanger medium is only ambient air (or ambient atmosphere). However, it is preferable if dedicated heat exchanger elements are used, which supply or remove heat or cold by passing a heat exchange medium through them.

In some embodiments, it is preferable to use heat exchanger elements which are based on structures such as those described in DE 10 2015 111 614 A1.

In the context of the multiple reactor arrangements according to the invention, it is possible in some embodiments to combine different reactors, which differ in their design from the reactors of the present invention, with reactors according to the invention. In these embodiments, it is useful if the various reactors have the same or at least approximately the same external dimensions. Accordingly, different or identical heat exchanger elements can also be used.

In most embodiments, however, it is preferable to combine only reactors according to the invention and only one type of heat exchanger element in the multiple reactor arrangements according to the invention; wherein, in particular, these all have the same external dimensions.

In the context of the present invention, the heat exchanger elements can be operated in co-current, cross-current or counter-current to the flow direction of the reaction medium, depending on the exact type of heat exchanger elements used and the heat exchange requirement of the reaction carried out in the reactors.

The exact arrangement of the reactors in such multiple reactor arrangements according to the invention is also widely variable. It is possible to arrange many reactors according to the invention on top of each other, next to each other or behind each other.

In the context of the multiple reactor arrangements according to the invention, it is possible in some embodiments to form a chessboard-like arrangement in which reactors, preferably reactors according to the invention, alternate with heat exchanger elements.

It is also possible to combine several such chessboard-like arrangements, preferably in such a way that they are arranged offset one above the other (by one “field” in each case)

The outer dimensions of the multiple reactor arrangements according to the invention are in principle not limited. Thus, within the scope of the present invention, it is quite possible to construct multiple reactor arrangements that are several metres high and wide in total. In preferred embodiments of the present invention, multiple reactor arrangements are obtained with a height of up to 2 metres, or up to 2.5 metres or up to 3 metres in height.

Examples of certain embodiments relating to multiple reactor arrangements according to the invention have the following sequences of the different components one above the other:
DPZPD-W-DPZPZPD-W-DPZPZPD-W-DPZPZPD-W-DPZPZPD-W-DPZPD;
DPZPD-W-DPZPZPZPD-W-DPZPZPZPD-W-DPZPZPZPD-W-DPZPZPZPD-W-DPZPD;
DPZPZPD-W-DPZPZPZPD-W-DPZPZPZPZPD-W-DPZPZPZPZPD-W-DPZPZPZPD-W-DPZPZPZPD.

Where D=cover layer, Z=intermediate layer, P=a pair of structural layers and W=heat exchanger element, in particular a pair of cooling foils according to DE 10 2015 111 614 A1 (FIG. 2).

These multiple reactor arrangements are merely exemplary and the present invention is by no means limited to them.

These multiple reactor arrangements can be arranged in a plurality next to each other, or can also be combined with other arrangements next to them.

Moreover, it is subject matter of the present invention to provide a method for manufacturing a reactor according to the invention by 3D printing or superimposing and then welding the individual layers, preferably by means of laser welding, electron beam welding or diffusion welding.

In preferred embodiments of the present invention, this method according to the invention is characterised in that

I) individual structural layers are produced, preferably by punching, laser cutting, water jet cutting or milling out the structure from a piece of material, a sheet of material or a film of material,

IIa1) several structural layers are arranged offset to each other, one above the other and between an upper cover layer and a lower cover layer, and

IIa2) the resulting multilayer stack is joined together by diffusion welding via the respective contact points and contact areas, or

IIb1) in each case a structural layer is arranged over a previous cover layer or structural layer, then

IIb2) the contact points and/or contact areas are joined together by means of laser welding,

IIb3) steps IIb1) and IIb2) are repeated according to the desired number of structural layers, and

IIb4) a final cover layer is applied and welded, wherein the individual layers are arranged in such a way that the overlap of the openings from one layer to the next is 30-60%, preferably 30 to 55%.

In further preferred embodiments of the present invention, the individual structural layers have an edge running around the structure during manufacture. In further preferred embodiments, this edge can be removed after welding.

In other preferred embodiments, the edge is not removed and forms the reactor wall after welding.

In further preferred embodiments of the present invention, openings for the fluid inlet and outlet are subsequently milled into front and rear sides of the structural layers after the other steps.

In further preferred embodiments of the present invention, the individual structural layers are adjusted to certain precisely defined external dimensions and then inserted precisely into an empty reactor housing.

This insertion can be carried out either individually for each structural layer one after the other or en bloc. The structural layers can either be welded together beforehand to form a block and then inserted into the housing as a block, or they can be welded together with cover layers after insertion into the housing.

The method according to the invention naturally also applies mutatis mutandis in the event that intermediate layers are arranged.

However, the sequence of steps is then, logically, adapted accordingly and step IIb4) is replaced as follows:

IIb4a)an intermediate layer is applied and welded,

IIb4b)steps IIb1) and IIb2) are carried out according to the desired number of structural layers arranged after the intermediate layer,

IIb4c) steps IIb4a) and IIb4b) are repeated as often as intermediate layers are to be arranged, and

IIb4z) a final cover layer is applied and welded.

In further preferred embodiments of the present invention, the process comprises the arrangement of catalyst retention devices, preferably net-like components or fine-pored metal or ceramic components, in particular fine-mesh wire nets, on the reactor front side and the reactor rear side. The catalyst retention device at the reactor front side is attached either during reactor manufacture or after filling with catalyst.

It is possible within the scope of the present invention that the method comprises the step of filling the reaction chamber with catalyst bed prior to applying the final cover layer.

In other, preferred embodiments of the present invention, the method comprises the step of filling the reaction chamber with catalyst bed after completion of the reactor from the reactor front side (as step III)). In this case, the filling process expediently comprises the steps of arranging the catalyst retention device on the reactor rear side (step IIIc), tilting the reactor onto the rear side (step IIIb) so that the reactor front side then faces upwards, filling the reactor with catalyst bed through the front side (step IIIc), optionally with shaking movements or the like, and arranging the catalyst retention device on the reactor front side (step IIId)). Preferably, at least one of the catalyst retention devices is arranged in such a way that it can be removed in a non-destructive manner in order to facilitate the replacement or removal of the catalyst.

Furthermore, in further embodiments, the reactors according to the invention can be provided with distribution nozzles or distribution spaces for the reaction medium at the front and rear sides (step IV)).

Last but not least, a subject matter of the present invention is the use of the reactors according to the invention or the multiple reactor arrangements according to the invention or one of the reactors produced by the method according to the invention for exothermic or endothermic reactions.

The reactors according to the invention, multiple reactors or reactors produced by the method according to the invention are particularly well suited for exothermic reactions, such as methanol synthesis or methanisation or Fischer-Tropsch syntheses, in particular Fischer-Tropsch syntheses.

In this respect, particularly preferred embodiments of the present invention relate to the use of the reactors according to the invention or the multiple reactor arrangements according to the invention or one of the reactors produced by the method according to the invention for methanol synthesis or methanisation or Fischer-Tropsch syntheses, in particular Fischer-Tropsch syntheses.

The present invention thus also relates in particular to welded multilayer structures for fluid redispersion and heat conduction in catalyst beds, as is also shown above and below.

The present invention is based on the fact that the developed structure, which is reminiscent of a net, is suitable in its shape for several joining processes and additive manufacturing processes.

The reactors according to the invention (see also FIG. 1) have many continuous contact points during apparatus construction, which can be joined perpendicular to the direction of flow through the plate stack, optionally by so-called diffusion welding as well as by beam processes, such as preferably laser welding or electron beam welding.

Accordingly, the present invention is also based on the fact that the flow through the reactor is evenly distributed through recurring structures, which are arranged in a regularly overlapping manner and each opening in a structural layer (plate) connects four openings located below and above it (see also FIG. 2). By this arrangement a recurring mixing and flow interruption in both spatial directions perpendicular to the direction of flow results, which leads to an equalisation of porosity differences in the catalyst filing as well as between particles close to the wall and particle-particle composite materials. This in turn achieves a uniform residence time of individual flow paths through the reactor. This avoids the need for high efforts to equalise the local particle bulk density.

In the present invention, the individual openings are large enough to easily accommodate particles, in particular catalyst particles/catalyst bed, with a diameter of 50-300 μm. At the same time, the arrangement allows the penetration of the structure with ultrasound (when filled with liquids) through the entire reactor in order to free the reactor from particle residues. This makes cleaning the reactor considerably easier. Among other things, this makes it possible for one and the same reactor to be used for a completely different reaction after cleaning and refilling with a different catalyst.

Accordingly, in the context of the present invention, there is no complete filling of the cavities with (liquid) catalyst, but a filling with catalyst bed, wherein the individual catalyst particles preferably have a particle size distribution of 50 pm to 500 pm, preferably 50 μm to 300 μm measured by laser diffraction.

An example of catalysts which can be used in reactors according to the invention in methanol syntheses in preferred embodiments are Cu/ZnO/Al₂O₃ catalysts with a particle size distribution of 200 μm to 400 μm, measured by laser diffraction.

An example of catalysts that can be used in reactors according to the invention in Fischer-Tropsch syntheses in preferred embodiments are cobalt-based catalysts with a particle size distribution of 50 μm to 200 μm, measured by laser diffraction.

Furthermore, in the context of the present invention, the intersecting connecting webs allow short paths of heat conduction through ordered, regular connection to the cooling passage. In addition, by the connection method (manufacturing method) a material-locking connection to the cooling passage is given, i.e. a mixing of reaction medium with heat exchanger medium is ruled out. Regardless of which connection method (manufacturing method) is ultimately used in the context of the present invention, there is no contact resistance due to the material-locking connection. The preferably highly conductive construction material passes through the catalyst region via the offset arrangement of the openings and the connection of one opening with four openings in the plane above (structural layer) as well as again with four openings in the plane below (structural layer). The distances to the contact points are arranged symmetrically and minimal in length. This results in short heat transport paths from the poorly thermally conductive catalyst material to the thermally conductive construction material and also short transport paths in the construction material.

In some embodiments of the present invention, the heat transport path as well as the ratio of heat transport path to particle size can thus be easily adapted via the thickness of the plates and the opening size. Both parameters are essentially dependent on the local heat release potential of the reaction and the employed particle size.

An advantage of the present invention is that it is suitable for several welding processes, taking into account the catalyst integration and removal as well as the isothermality in the reactor.

Advantageous is further that the geometry of the openings can be adapted in size and, together with the choice of the respective structural layer thickness, the number of heat conduction webs per volume as well as the width for filling with microparticles of different sizes can be variably adjusted. This means that the volume-related energy release can also be controlled and the number of cooling planes introduced into the system can be minimised or the catalyst volume per reactor volume maximised.

Particular advantageous are the simplified filling and emptying with catalyst, the high heat dissipation with simultaneous maximum volume utilisation with catalyst, a significantly improved residence time behaviour (narrower residence time distribution->plug flow behaviour despite local porosity differences in the particle bed).

From an economic and manufacturing point of view, it is also advantageous that simplified manufacturing processes and therefore considerable reduction in costs and thus competitiveness of the reactor technology compared to the standard multitubular tubular reactors is possible.

The openings in the structural layers of the present invention can, in some of the variants, simply be machined out of material foils by low-cost manufacturing processes such as punching, laser cutting and water jet cutting.

Furthermore, the possibility of manufacturing by means of laser welding or the like is advantageous, that this is easier to automate compared to diffusion welding, for example, and thus a considerable increase in the number of units per year becomes possible. Similar applies to the manufacture of the reactors according to the invention by means of additive manufacturing processes (3D printing), as this can be automated to a high degree. However, since production by diffusion welding is also still possible, the present invention is highly variable, which is a further advantage.

The skilled person can conduct the exact design of the devices described, insofar as these are not explicitly described in this description, such as size, wall thicknesses, materials etc. to the reaction conditions intended for a specific reaction within the scope of his general knowledge in the art.

If, in the description of the devices according to the invention, parts or the entire device are labelled as “consisting of”, it is to be understood that this refers to the essential components mentioned. Self-evident or inherent parts such as lines, valves, screws, housings, measuring devices, storage containers for reactants/products etc. are not excluded by this.

Unless explicitly described, the individual parts of the devices are in active connection with each other in a customary and known manner.

The various embodiments of the present invention, for example—but not exclusively—those of the various dependent claims, can be combined with one another in any desired manner, provided that such combinations do not contradict one another.

### FIGURE DESCRIPTION:

The present invention is explained in more detail below with reference to the drawings. The drawings are not to be interpreted as limiting and are not to scale. The drawings are schematic and furthermore do not contain all the features that conventional devices have, but are reduced to the features that are essential for the present invention and its understanding, for example screws, connections etc. are not shown or not shown in detail.

Identical reference signs indicate identical features in the figures, the description and the claims.

FIG. 1 shows a sectional view of a reactor 1 according to the invention. For clarity, the cover layers are not shown. This figure shows four structural layers 2 arranged one above the other. The structure consisting of webs 4 and openings 3 can be clearly seen. The openings 3 are square in the example in this figure. An edge 5 is also illustrated at the bottom right. In this illustration, the reactor is flowed with reaction fluid from the diagonal bottom left (=the front side); this is indicated in this figure by the arrows. Also illustrated are two contact points 6, i.e. points at which all structural layers are in contact with each other above one another or, in other words, points that are connected perpendicular to the direction of flow through all structural layers 2 (and cover layers) (there are, of course, more contact points per structural layer, but only two are shown here for the sake of clarity). The layers are joined together at these points, for example by laser welding, electron beam welding or diffusion welding; if the reactor is manufactured via 3D printing, the structure is built up continuously in a vertical direction at this point during printing. The heat (or cold) is then conducted via the contact points 6 to the cover layers not shown, from which, in turn, the heat (or cold) is then transferred to another medium, usually a heat exchanger medium. In the openings 3 catalyst particles can be arranged (not shown). In this figure it can also be clearly seen that the offset of the individual structural layers relative to each other, which here is 0.5 units of length (one unit of length equals the length of the side edge of an opening) in the x and y directions (x direction equals the direction of a side edge of an opening and y direction is orthogonal in the plane of the structural layer 2). The flow or flow direction A of the reaction fluid is illustrated by the arrows, as already mentioned. The fluid first flows into the open openings at the front side, which in this example are triangular (half or quarter squares). When the fluid then encounters webs, it is diverted upwards and/or downwards into openings 3 of the structural layer 2 above or below. Due to the special structure, a very uniform flow is achieved throughout the entire reaction space (i.e. the sum of all openings), even at the edge 5 of the reactor 1. This is indicated by the arrows.

FIG. 2 shows a section of a pair of foils 2 with slit-shaped offset slits in the edge 5, which form a continuous channel when placed on top of each other. The foils 2 are structures worked out of a material foil and thus - after they are arranged on top of each other in the finished reactor - each represent a structural layer 2 according to the invention.

FIG. 3 shows a section of a pair of foils 2 with an unstructured edge region 5. After the foils 2 have been arranged on top of each other and joined together, for example by means of laser welding or a diffusion welding process, the edge region 5 can be removed, for example by milling in the direction of flow. As in FIG. 3, the foils 2 are structures worked out of a material foil and therefore each represent a structural layer 2 according to the invention after they are arranged on top of each other in the finished reactor.

FIGS. 4 and 5 show for the Fischer-Tropsch synthesis (FIG. 4) and for the methanol synthesis (FIG. 5) and various materials a plot of the ratio of web width to side length of the opening on the x-axis (horizontal axis) against the permitted stack height between cooling planes in mm at 5K temperature lift on the y-axis (vertical axis). The left vertical line in each case indicates the limit of weldability, the right vertical line in each case the limit of catalyst bed. In FIGS. 4 and 5, the “triangle” in the symbols of the measured values stands for nickel as the material, the “vertically crossed-out x” for mild steel, the “x” for titanium, the “circle” for stainless steel and the “dash” for a Ni-based material. From these examples an ideal ratio of web width to side length of the opening between 0.25 and 0.45 result.

FIGS. 6A and 6B shows alternative embodiments of the preferred diamond structure according to the invention in plan view. FIG. 6A shows a single structural layer 2 and FIG. 6B a view of several structural layers 2 arranged one above the other. By a reinforced web in the centre of the opening increased area portions for the joint connection 6 are provided, so that the portion of catalyst volume within the structure is not significantly reduced, but the heat flow through the stack of different structural layers can be further increased. This can be particularly advantageous with highly active catalyst.

FIG. 7 shows the measurement data described in example 2. The time is plotted on the x-axis (in the format hh:mm:ss), the temperature in ° C. on the y-axis on the left and the methane selectivity on the y-axis on the right.

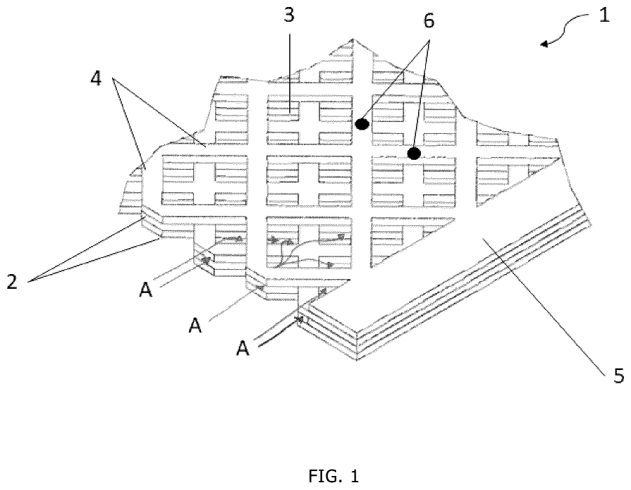

### List of Reference Signs:

1 sectional view of reactor
2 structural layer(s) (or material film)
3 opening
4 web
5 edge (region)
6 contact point (of structural layers laying one on another) A (direction of flow of) reaction medium

### EXAMPLES:

The invention will now be further explained with reference to the following non-limiting examples. In each of the experiments, several reactors according to the invention were arranged one above the other to form a multiple reactor arrangement according to the invention. The multiple reactor arrangements of the two examples were almost identical.

The reactors differed only in the number and thickness of the structural layers (foils) and with regard to the stack structure. The common data are
catalyst bed/structure length 283 mm
catalyst bed/structure width 65 mm
square cut-outs with 6 mm
web width 1.5 mm

The stacking sequence for methanol synthesis (example 1) from above or below:

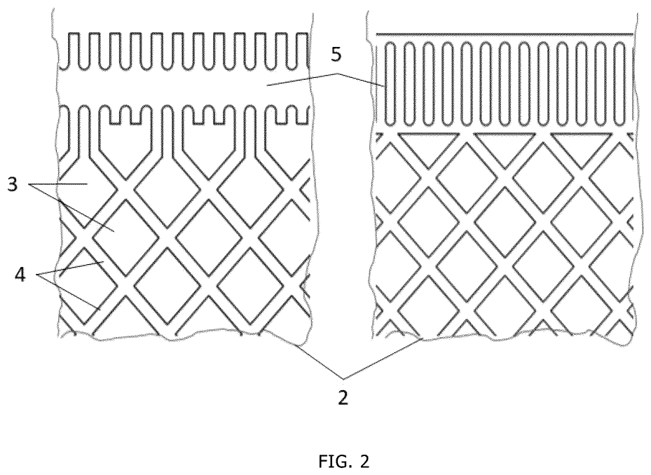

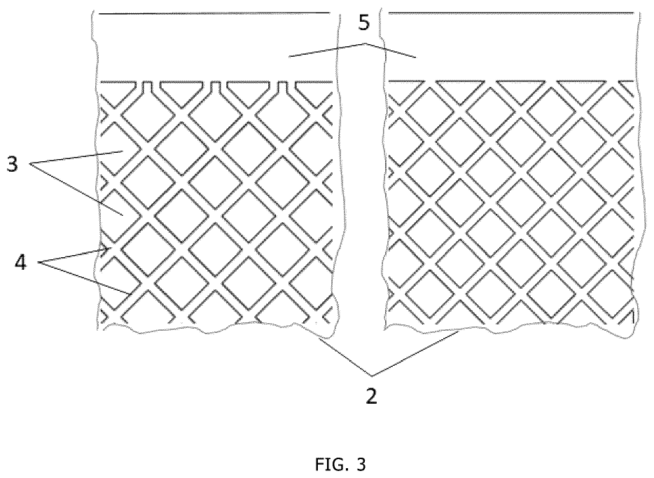

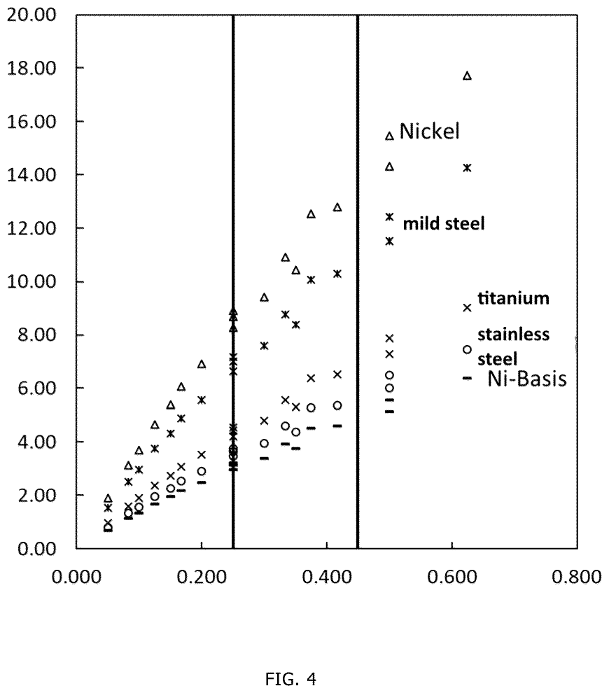

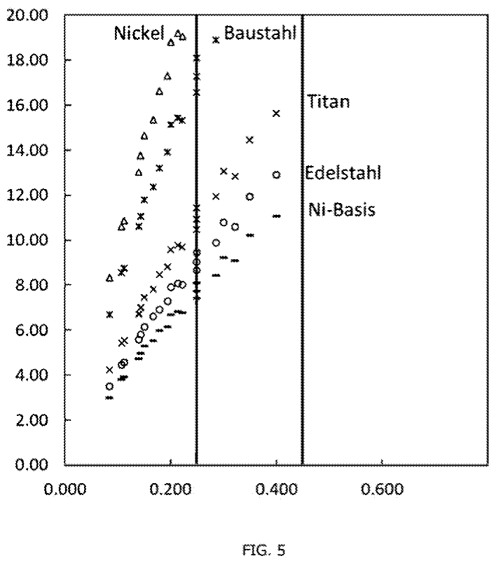

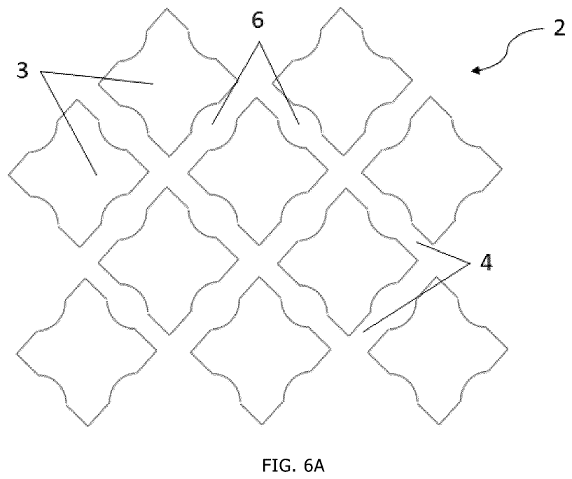

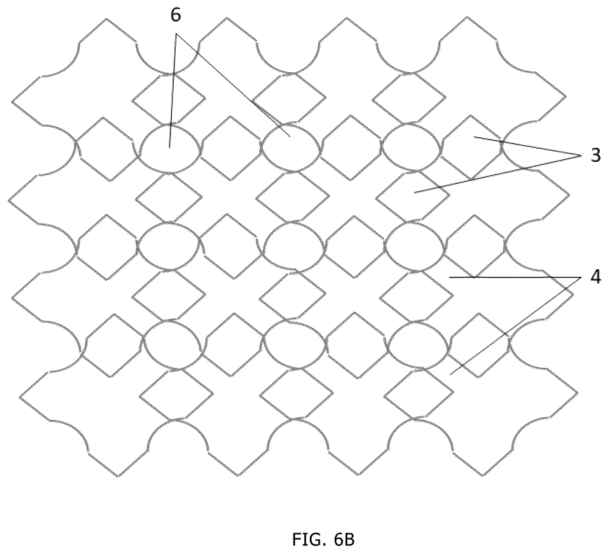

2 pairs of structural layers (reaction foil) 0.6 mm thick each with an intermediate and final cover layer (unstructured plate) 1 mm thick
one cooling foil pair according to the prior art (DE 10 2015 111 614 A1, FIG. 2—these are always the same in the following)
4 pairs of structural layers (reaction foil) 0.6 mm thick, each with an intermediate and final cover layer (unstructured plate) 1 mm thick
one pair of cooling foils according to the prior art
4 pairs of structural layers (reaction foil) 0.6 mm thick, each with an intermediate and final cover layer (unstructured plate) 1 mm thick
one pair of cooling foils according to the prior art
4 pairs of structural layers (reaction foil) 0.6 mm thick, each with an intermediate and final cover layer (unstructured plate) 1 mm thick
one pair of cooling foils according to the prior art
4 pairs of structural layers (reaction foil) 0.6 mm thick, each with an intermediate and final cover layer (unstructured plate) 1 mm thick
one pair of cooling foils according to the prior art
4 pairs of structural layers (reaction foil) 0.6 mm thick, each with an intermediate and final cover layer (unstructured plate) 1 mm thick
one pair of cooling foils according to the prior art
pairs of structural layers (reaction foil) 0.6 mm thick, each with an intermediate and final cover layer (unstructured plate) 1 mm thick

The stacking sequence for Fischer-Tropsch synthesis (example 2) from above or below:
3 pairs of structural layers (reaction foil) 0.6 mm thick, each with an intermediate and final cover layer (unstructured plate) 0.4 mm thick
one pair of cooling foils according to the prior art
5 pairs of structural layers (reaction foil) 0.6 mm thick, each with an intermediate and final cover layer (unstructured plate) 0.4 mm thick
one pair of cooling foils according to the prior art
5 pairs of structural layers (reaction foil) 0.6 mm thick, each with an intermediate and final cover layer (unstructured plate) 0.4 mm thick
one pair of cooling foils according to the prior art
5 pairs of structural layers (reaction foil) 0.6 mm thick, each with an intermediate and final cover layer (unstructured plate) 0.4 mm thick
one pair of cooling foils according to the prior art
5 pairs of structural layers (reaction foil) 0.6 mm thick, each with an intermediate and final cover layer (unstructured plate) 0.4 mm thick
one pair of cooling foils according to the prior art
5 pairs of structural layers (reaction foil) 0.6 mm thick, each with an intermediate and final cover layer (unstructured plate) 0.4 mm thick
one pair of cooling foils according to the prior art 3 pairs of structural layers (reaction foil) 0.6 mm thick, each with an intermediate and final cover layer (unstructured plate) 0.4 mm thick

### Example 1 (methanol synthesis):

The multiple reactor arrangement was operated in a MeOH synthesis starting from CO₂ and H₂ at 30 bar and at 250° C. The reaction feed with a molar ratio of H₂:CO₂ of 3 (stoichiometric according to the reaction) was preheated to the reaction temperature with a total amount of 120 to 140 L/min (at standard conditions) and sent into the multiple reactor arrangement. The multiple reactor assembly was filled with 257 g of industrially available highly active Cu/ZnO/Al₂O₃ catalyst of the 200-400 μm grain fraction. After separation of methanol and reaction water, 90% of the unreacted reactant was recycled with a compressor. The conversion was therefore over 90% due to the recirculation. Between 100 and 150 ml of methanol were produced per hour. The multiple reactor arrangement was operated with a boiling water circuit at increased pressure to cool the reaction. No catalyst deactivation was found over several hundred hours, which would be possible if temperature gradients were to occur in the reactors.

### Example 2 (Fischer-Tropsch Synthesis):

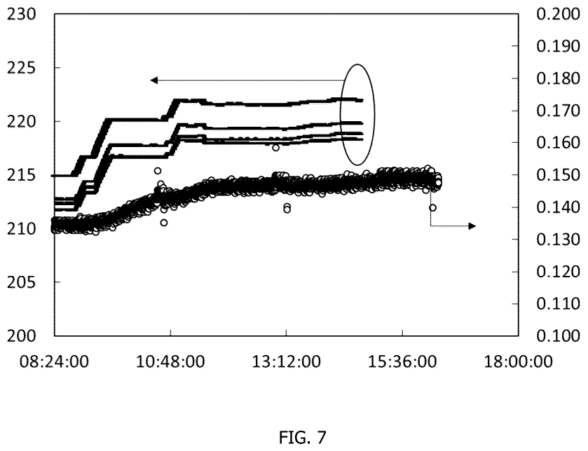

The multiple reactor arrangement was operated in a Fischer-Tropsch synthesis starting from CO and H₂ at 20 bar and at a target temperature of 215° C. The reaction feed consisted of 20.6 L/min CO, 44.3 L/min CO diluted with 21.4 L/min N₂ (all data at standard conditions). The feed was preheated to approximately the reaction temperature (210° C.) and sent to the multiple reactor arrangement. The multiple reactor arrangement was filled with 450 g of highly active industrially produced cobalt catalyst of grain fraction 50 200 μm. Heat was again removed with a boiling water circuit. The temperatures in the catalyst beds were recorded along the reaction coordinate. The temperatures varied between 216.9° C. to 220.4° C. with a boiling temperature of the water of 213° C. The temperature differences were therefore within the expected range according to the measurement errors (+3° C. within the bed; +7° C. between the water temperature and the catalyst; the latter figure is not decisive as the heat transport is influenced by the wall between the two fluids and thus apparently slightly increases the gradient). Since in this example the multiple reactor arrangement was operated in single- pass mode (one pass without recycling of unreacted gas), it was possible to determine the conversion of CO in one reactor pass. This was at about 69%. FIG. 7 shows the four recorded temperatures as well as the course of the methane selectivity when the target temperature was changed from 212° C. to 218° C. under otherwise identical conditions. A rapid adaptation of the reaction temperature can be seen when changing the boiling pressure of the water cooling without thermal runaway. In addition, with the set dilution with N₂ (reduced CO partial pressure), the methane selectivity value (at mean temperature of 220° C.) was within the expected value of 15% for isothermal operation. The measurement of the methane selectivity is shifted on the time axis due to the recording in the analytics with intermediate volumes of the separation containers for the liquid and waxy products.

The selectivity was thus used to evaluate the heat removal from the reaction system, because the selectivities to the different products change depending on the level of isothermality reached in the catalyst zone. The results from the heat removal showed that the expected properties are given. The methane selectivity values obtained are an indication that there are no undetected hotspots.

1. A reactor with multilayer structure comprising
an upper fluid-tight cover layer,
a lower fluid-tight cover layer,
fluid-tight side walls
and at least one reaction space located therebetween, which is defined by several superimposed structural layers parallel to the cover layers, wherein
individual ones of the structural layers each have a structure of parallelograms arranged periodically in several rows, each arranged edge-to-edge, and wherein a respective area of the parallelograms is designed as openings having edges and said edges comprise webs,
each structural layer is offset by a factor of 0.5±0.2 and 0.5±0.2 in an x direction and a y direction relative to the layer above and below the respective structural layer respectively, wherein a largest edge length of the parallelograms is standardised as 1 and specifies the x direction and the y direction is orthogonal to this in a plane of the structural layer,
the side edges of the parallelogram structures in the structure layers are arranged rotated by 30 to 60° in relation to a front side and a rear side of the reactor, resulting in incomplete parallelogram structures with openings not completely surrounded by webs at the front and rear sides of the reactor,
the reaction space is laminary flowed against from the front side of the reactor, wherein a flowed-against fluid flows into the openings that are not completely surrounded by webs,
the front and the rear sides of the reactor are configured for an inflow and an outflow of reaction medium,
the cover and structural layers are made of material with good thermal conductivity,
a number of contact points and areas of the webs of the superimposed structural layers are fully connected to each other,
a catalyst bed is arrangeable in the openings between the webs of the structural layers,
and wherein an overlap of the openings of one of the structural layers by the webs of an overlying one of the structural layers is 30-60%.

2. The reactor according to claim 1, wherein
the structural layers each have a thickness of 0.3 mm to 2 mm, preferably 0.5 mm to 1 mm,
a web width is from 0.5 mm to 4 mm, preferably from 1 mm to 3 mm,
the largest side length of the openings is between 2 mm and 20 mm, preferably between 4 mm and 12 mm,
wherein the openings are wider than the web width by at least a factor of 2, preferably at least a factor of 3.

3. The reactor according to claim 1, wherein a ratio of a web width to a longest side length of the openings is between 0.15 and 0.55.

4. The reactor according to claim 1, wherein the reactor has an empty volume portion of 45 vol. % to 75 vol. %.

5. The reactor according to claim 1, wherein there are 2 to 10 structural layers, said structural layers arranged between the cover layers.

6. The reactor according to claim 1, wherein the structural layers additionally have one or more edges on the front and rear sides with incorporated channels for distributing the reaction medium during inflow and outflow.

7. The reactor according to claim 1, wherein, in addition to the cover layers and the structural layers, the reactor also has one or more intermediate layers which are arranged between structural layers, where there are at least two structural layers arranged on each side of an intermediate layer before a further intermediate layer or a cover layer is arranged.

8. The reactor according to claim 1, wherein the webs are widened at points at which the webs are in contact with those of an underlying or overlying one of the structural layers.

9. A multiple reactor arrangement comprising a plurality of reactors according to claim 1, wherein the plurality of reactors are stacked, wherein heat exchanger elements are arranged between individual ones of the plurality of reactors in each case.

10. A method of manufacturing a reactor according to claim 1, wherein the reactor is produced by 3D printing or superimposing and then welding the individual layers, preferably by means of laser welding or diffusion welding, and optionally catalyst bed is arranged in the openings between the webs of the structural layers.

11. The method according to claim 10, wherein:
I) individual structural layers are produced, preferably by punching, laser cutting, water jet cutting or milling out the structure from a piece of material, a sheet of material or a foil of material,
IIa1) several structural layers are arranged offset to each other, one above the other and between an upper cover layer and a lower cover layer, and
IIa2) a resulting multilayer stack is joined together by diffusion welding via the respective contact points and contact areas,
or
IIb1) in each case a structural layer is arranged over a previous cover layer or structural layer, then
IIb2) the contact points and/or contact areas are joined together by means of laser welding,
IIb3) steps IIb1) and IIb2) are repeated according to a desired number of structural layers, and
IIb4) a final cover layer is applied and welded,
wherein the individual structural layers are arranged in such a way that the overlap of the openings from one layer to a next is 30-60%, preferably 30 to 55%.

12. The method according to claim 11, wherein act IIb4) is replaced by the steps:
IIb4a) an intermediate layer is applied and welded,
IIb4b) steps IIb 1) and IIb2) are carried out in accordance with the desired number of structural layers arranged after the intermediate layer,
IIb4c) steps IIb4a) and IIb4b) are repeated as often as intermediate layers are to be arranged, and
IIb4z) a final cover layer is applied and welded.

13. The method according to claims 10, wherein the structural layers have an edge running around the structure during production, which is preferably removed after welding.

14. The method according to claim 13, wherein subsequently to the other acts, milling openings for a fluid inlet and a fluid outlet into the front and rear sides of the structural layers.

15. A method of using a reactor according to claim 1 for exothermic or endothermic reactions, preferably exothermic reactions, particularly preferably methanol synthesis or methanisation or Fischer-Tropsch syntheses, in particular Fischer-Tropsch syntheses.

16. The reactor according to claim 1, wherein
the structural layers each have a thickness of 0.3 mm to 2 mm, preferably 0.5 mm to 1 mm,
a web width is from 1 mm to 3 mm,
the largest side length of the openings is between 4 mm and 12 mm,
wherein the openings are wider than the web width by at least a factor of 2, preferably at least a factor of 3.

17. The reactor according to claim 1, wherein a ratio of a web width to a longest side length of the openings is between 0.25 and 0.45.

18. The reactor according to claim 1, wherein a ratio of a web width to a longest side length of the openings is between 0.15 and 0.55, preferably between 0.25 and 0.45.

19. The reactor according to claim 1, wherein the reactor has an empty volume portion of 50 vol. % to 70 vol. %.

20. The reactor according to claim 1, wherein the reactor has an empty volume portion of 60 vol. % to 70 vol. %.
